(19) United States
(12) Patent Application Publication
(10) Pub. No.: US 2025/0376057 A1
(43) Pub. Date: Dec. 11, 2025

(54) SYSTEM AND METHOD FOR PROVIDING NOTIFICATIONS REGARDING A VEHICLE BATTERY CHARGE OPERATION

(71) Applicant: Ford Global Technologies, LLC, Dearborn, MI (US)

(72) Inventors: Sathyanarayana Chary Palakonda, Northville, MI (US); Syed Amaar Ahmad, Canton, MI (US); Bryan Michael Bolger, Canton, MI (US); Maria Fernanda Mohar, Atizapán de Zaragoza (MX); John Eric Rollinger, Troy, MI (US)

(21) Appl. No.: 18/734,565

(22) Filed: Jun. 5, 2024

(51) Int. Cl. B60L 53/30; B60L 53/66; H04W 4/02

(52) U.S. Cl. CPC B60L 53/305; B60L 53/66; H04W 4/025; B60L 2250/10

(57) ABSTRACT

A method includes charging a battery pack of a vehicle in response to an electric vehicle supply equipment (EVSE) being connected to a charge port of the vehicle, detecting a position of a paired device associated with a vehicle user in response to receiving a wireless signal from the paired device, and outputting a power load notification indicating excessive power being drawn from the battery pack in response to the battery pack being charged and a power load on the battery pack being greater than or equal to a power draw threshold. The power load notification is at least one of a message provided to the paired device or an audio signal outputted via a selected audio device of the vehicle in response to the position of the paired device being within an audio zone of the vehicle.

### TECHNICAL FIELD

The present disclosure is generally directed to a battery charge operation for an electric vehicle, and more specifically, providing a notification regarding the charge operation.

### BACKGROUND

The statements in this section merely provide background information related to the present disclosure and may not constitute prior art.

An electric vehicle (EV), such as plug-in hybrid vehicles and fully electric vehicles, generally connect to an electric vehicle supply equipment (EVSE) to charge a high voltage battery pack of the EV using power from a power grid. For the charge operation, a user connects a charger of the EVSE to a charge port of the EV, and is then free to leave the EV. However, in some instances, even if the EVSE is connected to the EV, issues may arise during charging that the user may not be aware, especially if the user is not at the EV (e.g., the charger is not being properly connected).

### SUMMARY

This section provides a general summary of the disclosure and is not a comprehensive disclosure of its full scope or all of its features.

In one form, the present disclosure is directed to a method that includes charging a battery pack of a vehicle in response to an electric vehicle supply equipment (EVSE) being connected to a charge port of the vehicle, detecting a position of a paired device associated with a vehicle user in response to receiving a wireless signal from the paired device, and outputting a power load notification indicating excessive power being drawn from the battery pack in response to the battery pack being charged and a power load on the battery pack being greater than or equal to a power draw threshold. The power load notification is at least one of a message provided to the paired device or an audio signal outputted via a selected audio device of the vehicle in response to the position of the paired device being within an audio zone of the vehicle.

In one form, the present disclosure is directed to a vehicle system that includes a battery pack, a plurality of audio devices defining an audio zone, a first communication device configured to communicate using a first wireless communication protocol, a plurality of second communication devices configured to communicate using a second wireless communication protocol and disposed at two or more known locations, and one or more controllers. The one or more controllers is configured to have the battery pack charged in response to an electric vehicle supply equipment (EVSE) being connected to a charge port, detect a position of a paired device associated with a vehicle user in response to receiving a wireless signal from the paired device, and output a power load notification indicating excessive power being drawn from the battery pack in response to the battery pack being charged and a power load on the battery pack being greater than or equal to a power draw threshold. The power load notification is at least one of a message provided to the paired device or an audio signal outputted via a selected audio device among the plurality of audio devices in response to the position of the paired device being within the audio zone.

In one form, the present disclosure is directed to a vehicle system including a battery pack, a plurality of audio devices defining an audio zone, a first communication device configured to communicate using a first wireless communication protocol, a plurality of second communication devices configured to communicate using a ultra-wide band communication protocol and disposed at two or more known locations, and one or more controllers. The one or more controllers is configured to have the battery pack charged in response to an electric vehicle supply equipment (EVSE) being connected to a charge port, detect a position of a paired device associated with a vehicle user in response to receiving a wireless signal from the paired device, identify a selected audio device from among the plurality of audio devices based on the position of the paired device and information indicating placement of each audio device, output a power load notification indicating excessive power being drawn from the battery pack in response to the battery pack being charged and a power load on the battery pack being greater than or equal to a power draw threshold, and output a battery charge status audio notification from the selected audio device in response to the EVSE being connected to a charge port and in response to the position of the paired device being within the audio zone. The power load notification is at least one of a message provided to the paired device or an audio signal outputted via the selected audio device in response to the position of the paired device being within the audio zone.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates an electric vehicle (EV) connected to an electric vehicle supply equipment (EVSE);

FIG. 2 illustrates the EV of FIG. 1 having an audio zone about the EV;

FIG. 3A is a flowchart of a charge routine; and

FIG. 3B is a flowchart of a charge load detection routine of FIG. 3A.

The drawings described herein are for illustration purposes only and are not intended to limit the scope of the present disclosure in any way.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

During a charge operation of an EV, issues may arise that can require the attention of a user of the EV. In a non-limiting example, an electric device, such as a laptop or tool, may be connected to the EV to draw power from a battery pack even with the battery pack charging. If the amount of power being drawn is excessive, the electric device can negatively affect the charge operation (e.g., the rate at which the battery pack is charging may decrease). In addition, when the user is near the EV, the user may not be aware of the charge status of the EV (e.g., latest state of charge (SOC) of the EV).

In one form, the present disclosure is directed to a system and/or method for monitoring the charge operation of the battery pack and providing a notification (e.g., audio notifications, RF notification based on user position) when there is excessive power being drawn from the battery pack. In an illustrative example, the battery pack begins charging in response to an EVSE being connected to a charge port of the EV and, if applicable, a charge schedule indicates the charge operation is to commence. The EV is configured to output a power load notification indicating excessive power being drawn from the battery pack in response to a power load on the battery pack being greater than or equal to a power draw threshold. The power load notification may be at least one of a message provided to a paired portable computing device associated with the user or an audio signal outputted via a selected audio device of the EV in response to the paired portable computing device being within an audio zone of the EV.

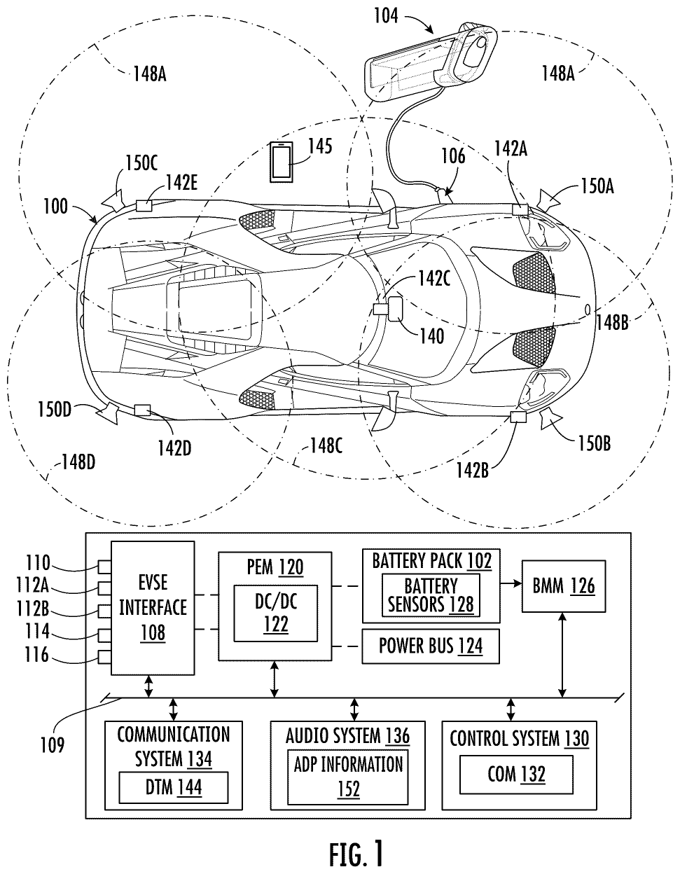

Referring to FIG. 1, an electric vehicle (EV) 100, such as a plug-in hybrid vehicle or a fully electric vehicle, includes a battery pack 102 that is chargeable via an electric vehicle supply equipment (EVSE) 104. The EVSE 104 provides circuitry and controls to manage the transfer of electrical energy between an external power source (e.g., electric power grid) and the EV 100. In one form, the EVSE 104 includes a charge connector 106 for plugging into an EVSE interface 108 (e.g., charge port) of the EV 100. In FIG. 1, dashed-lines generally represent power and solid lines represent exchange of information. Components of the EV 100 may be in communication using a vehicle communication network 109 (e.g., controlled area network (CAN) or local interconnect network (LIN)).

In one form, the EVSE interface 108 is configured to have an EV conductive ground terminal 110, EV conductive power terminals 112A, 112B (collectively “power terminals” 112), a proximity pin 114, and a control pilot 116. In a non-limiting example, the EVSE interface 108 is configured based on EV charger standards, such as but not limited to, combined charging system (CCS). The proximity pin 114 detects the charger connector 106 to detect that the EV 100 is connected to the EVSE 104. The control pilot 116 is a communication port to establish communication with the EVSE 104 using, for example, pulse-width modulation (PWM) per one or more communication standards (e.g., standards IEC 61851-1; DIN SPEC 70121; and/or the ISO/IEC 15118-series). In a non-limiting example, the EV 100 exchanges information, such as, but not limited to, SOC of the battery pack 102, an electric current measurement of the battery pack 102, and/or whether the battery pack 102 is to be charged.

The EV 100 further includes a power electronic module (PEM) 120 configured to coordinate the delivery of power to the battery pack 102 and charge the battery pack 102 using power from the EVSE 104 via the power terminals 112. In one form, among other components, the PEM 120 includes a DC/DC converter 122 to condition power supplied from the EVSE 104 and provide the proper voltage and current levels to the battery pack 102. The PEM 120 may further be configured to provide power from the battery pack 102 to a power bus 124 that supplies power to other electrical systems in the EV 100 such as, but not limited to, electric heater, heat pump, controllers, and low-voltage (LV) loads such as an auxiliary battery that supplies power to auxiliary power ports in the EV 100 to allow electric devices to draw power from the battery pack 102. The PEM 120 may monitor an overall power load on the battery pack 102 based on data from the battery pack 102 and the load or power being drawn by the power bus 124.

In one form, the EV 100 includes a battery management module (BMM) 126 configured to estimate one or more operating characteristics of the battery pack 102 using data from one or more battery sensors (BS) 128 provided with the battery pack 102. In a non-limiting example, the BS 128 includes voltage sensors, current sensors, and/or temperature sensors to detect operation characteristics of the battery pack 102, such as but not limited to, voltage, electric current, and/or temperature. Using the data, the BMM 126 may further determine other operating characteristics such as but not limited to, an open charge voltage, SOC, and/or power limit.

The EV 100 further includes a control system 130 to coordinate the operation of the various components of the EV 100. In a non-limiting example, the control system 130 includes one or more controllers configured to perform the necessary control functions for operating the EV 100. The control system 130 may be a combination of a vehicle control system and powertrain control module (VSC/PCM). In one form, using the operating characteristics of the battery pack 102 from the BMM 126, the control system 130 is configured to draw power from the battery pack 102 based on driver demand and other considerations.

Among other control modules, the control system 130 includes a charge operation module (COM) 132 that is configured to have the PEM 120 charge the battery pack 102 using various factors such as but not limited to, whether the EVSE interface 108 is connected to the EVSE 104 as detected by the proximity pin 114, the SOC of the battery pack 102 provided by the BMM 126, and/or a charge schedule identifies when the battery pack 102 is to be charged (e.g., the charge schedule indicates the battery pack 102 is to be charged in the evening when demand for power is low). As detailed herein, the COM 132 is further configured to provide various audio notifications to a user of the EV 100 regarding a charge operation of the EV 100, as described herein.

To provide notifications to the user, the EV 100 further includes a communication system 134 and an audio system 136. In one form, the communication system 134 includes a plurality of communication devices 140, 142 (e.g., 142A, 142B, 142C, 142D, 142E) and a device tracking module (DTM) 144 configured to estimate a position of the user by detecting a position of a portable computing device 145 associated with the user (e.g., smart phone, tablet, smart watch or other wearable, laptop).

The plurality of communication devices 140, 142 are configured to communicate with the portable computing device 145 using different wireless communication protocols. In a non-limiting example, the EV 100 includes a first communication device (FCD) 140 (e.g., BLUETOOTH (BT) type communication device), and a plurality of second communication device (SCD) 142A, 142B, 142C, 142D, 142E (collectively “SCD device 142”) (e.g., ultra-wideband (UWB) devices). The FCD 140 is configured to communicate using, as a first wireless communication protocol (e.g., BT low energy protocol and/or BT classic protocol) and the SCD 142 are configured to communicate using, as a second wireless communication protocol (e.g., UWB protocol). While specific communication devices/protocols are provided, other communication devices/protocols may be employed along with or in lieu BT and/or UWB. In a nonlimiting example, the communication system 134 may employ near field communication and cellular protocols. In the following the FCD 140 and the SCD 142 are collectively referred to as communication devices 140, 142.

The communication system 134 is configured to pair with the portable computing device 145 of the user per a respective protocol making it a paired device 145. Once paired, the communication system 134 is configured exchange messages in the form of signals with the paired device 145 using, for example, the first and/or second wireless communication protocols.

In one form, the DTM 144 is configured to detect a position of the paired device 145 associated with the user using a wireless signal received from the paired device 145. For example, each SCD 142 defines a communication region 148 (regions 148A, 148B, 148C, 148D, and 148E) within which the SCD 142 is able to receive (or transmit) signals from (or to) the paired device 145. In addition, the location of the each SCD 142 is known and stored by the DTM 144. It should be readily understood that while the regions 148 are illustrated in the two-dimensional plane (e.g., width and depth), the regions 148 also include a third dimensional axis (e.g., vertical/height). In addition, the number, size, and/or shape of the regions 148 may be different from what is being illustrated and each region 148 may be different from each other.

Once at one or more region 148, the DTM 144 is configured to detect a position of the paired device 145 using one or more signal processing techniques such as, but not limited to, time of flight, angle of arrival, and/or trilateration. In a non-limiting example, the DTM 144 is configured to detect the position of the paired device 145 as a coordinate, a distance from the SCD 142 closest to the paired device 145, and/or as the communication region 148 associated with the SCD 142 closest to the paired device 145. If the paired device 145 is detected, the DTM 144 is configured to provide information indicative of the position of the paired device 145 via the network 109.

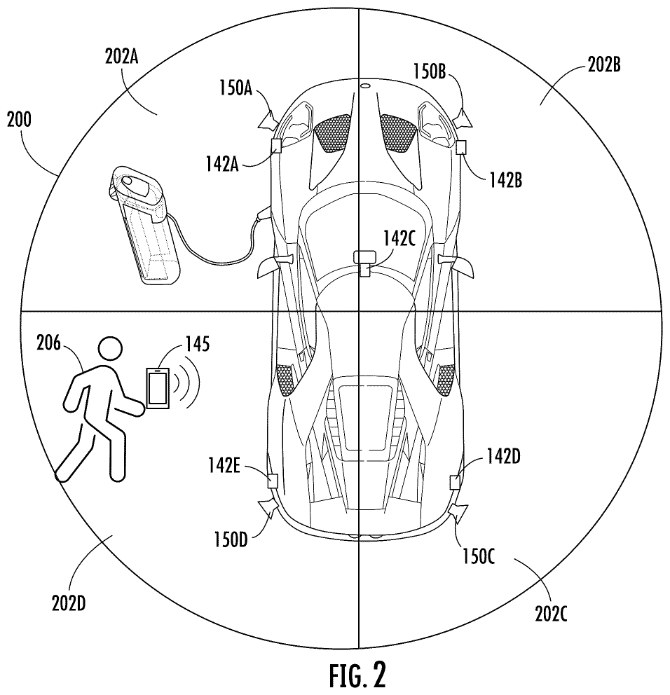

The audio system 136 includes a plurality of audio devices 150A, 150B, 150C, 150D (collectively “audio devices 150”) (e.g., speakers) to emit sound outward to the external environment. In a non-limiting example, referring to FIG. 2, the audio devices 150 are distributed about the EV 100 to define an audio zone 202 that is further defined by multiple sub-audio zones 204. The audio system 136 is configured to control one or more of the audio devices 150 to output an audio sound (e.g., a power load notification, a battery charge status notification, or an incomplete connection audio notification). The audio system 136 is configured to select or identify an audio device 150 from among the plurality of audio devices 150 based on, at least, an audio device placement (ADP) information 152 that associates each audio device 150 with at least a position on the EV 100. In a non-limiting example, the ADP information 152 provides the position as a region of the EV 100 (e.g., audio device 150A is at a front left region of the EV 100), associates each audio device 150 with at least one SCD 142 (e.g., the audio device 150A is associated with SCD 142A).

In one form, with the position of the paired device 145, the audio system 136 is configured to select the audio device 150 to emit the audio notification for the user. For example, in FIG. 2, the DTM 144 is configured to detect the paired device 145 associated with a user 206 and determines a position of the paired device 145. In the example of FIG. 2, the user 206 is believed to be in proximity to the paired device 145, and therefore, the position of the paired device 145 is associated or estimated to be the position of the user 206. The position of the paired device 145 may be used by the audio system 136 to select the audio device 150 for emitting the audio notification. For example, the DTM 144 determines the position of the paired device 145 based on the location of the SCD 142E, which is closest to the paired device. The audio system 136 may then select the audio device 150D using the ADP information 152 which associates the SCD 142E with the audio device 150. In another example, if the paired device 145 is located between two audio devices 150, the audio system 136 may employ both audio device 150 to emit the audio notification.

With continuing reference to FIG. 1, the COM 132 is configured to monitor a charge operation of the battery pack 102 and provide a notification (e.g., audio notification) to the user via the audio system 136. In one form, the COM 132 is further configured to provide notifications indicative of a power load on the battery pack 102 during the charge operation and/or a charge status of the battery pack 102 (e.g., a notification indicating the SOC of the battery pack 102).

In one form, the COM 132 is configured to determine if the EV 100 is connected to the EVSE 104 via the proximity pin of the EVSE interface 108, and outputs an audio signal indicative of a connection complete audio notification using the audio system 136. In the event connection to the EVSE is not detected (e.g., error associated with the proximity pin), but information is being received via the control pilot 116, the COM 132 is configured to output an audio signal indicative of an incomplete connection notification indicating that the charge connector 106 is not properly connected.

In addition to an audio notification regarding the connection of the EVSE 104 to the EVSE interface 108, an audio notification may be provided if an error has occurred at the EVSE 104 resulting in the EVSE 104 not being able to charge the EV 100. This error may be communicated to the EV 100 via the control pilot 116.

Once connected, the COM 132 initiates a charge operation of the battery pack 102 based on a charging schedule, and the connection complete audio notification may include information indicating the EV 100 is to begin charging at a scheduled time provided by the charging schedule. If there is no charge schedule, the COM 132 may have the PEM 120 begin charging.

With the battery pack 102 charging, the COM 132 determines if a battery charge status audio notification should be provided based on the position of the paired device 145. That is, if the DTM 144 detects the paired device 145, the COM 132 determines that the paired device 145 is provided within the audio zone 200 of the EV 100 and outputs an audio signal indicative of battery charge status providing a charge level of the battery pack 102 (e.g., SOC) to the audio system 136.

In one form, with the paired device 145 being in the audio zone 200, the COM 132 is configured to periodically output the battery charge status audio notification based on a charge level of the battery pack 102 (e.g., the battery charge status audio notification is provided when the SOC increases incrementally in steps of 5% or 10% or other suitable value). The paired device 145 may be provided in different sub-audio zones 204, and therefore the audio system 136 may employ different audio devices 150 to emit the audio notification, but information regarding the charge level is periodically provided.

In the event the paired device 145 is not detected by the SCD 142 and thus, outside of the audio zone, the audio devices 150 provides no audio notifications. In addition, when the paired device 145 is detected again, the COM 132 is configured to have the audio system 136 output the battery charge status audio notification with the present charge level of the battery pack 102. In one form, the DTM 144 may track that last time the paired device 145 was detected and the COM 132 is configured to provide the battery charge status audio notification based on the periodic schedule when the period of time between the last detection and current detection is less than or equal to a timeout period (e.g., 5 mins, 2 mins, 15 mins). Alternatively, once the paired device 145 is not detected and is then detected again, the COM 132 is configured to provide the present or latest charge level in the battery charge status audio notification regardless of the duration.

The COM 132 is further configured to monitor the power load on the battery pack 102 based on data from the PEM 120, and if the power load is greater than or equal to a power draw threshold, the COM 132 is configured to output a power load notification indicating excessive power being drawn from the battery pack 102. In one form, the power draw threshold (e.g., 11 kW) is set based on the rate at which battery pack 102 is being charged to inhibit the battery pack 102 from not charging even if the EVSE 104 is connected.

The power load notification may be an audio notification outputted via a selected audio device 150 when the paired device 145 is within the audio zone 200. In addition to or in lieu of the audio notification, the power load notification may be a message transmitted to the paired device 145 using a wireless communication protocol other than the wireless communication protocol used for the detecting the paired device 145. For example, the message may be transmitted using BT-type protocol or a cellular protocol. Once notified, the user of the paired device 145 may disconnect the electric device or if applicable, the EV 100 may electrically disconnect the electric device from the power bus 124.

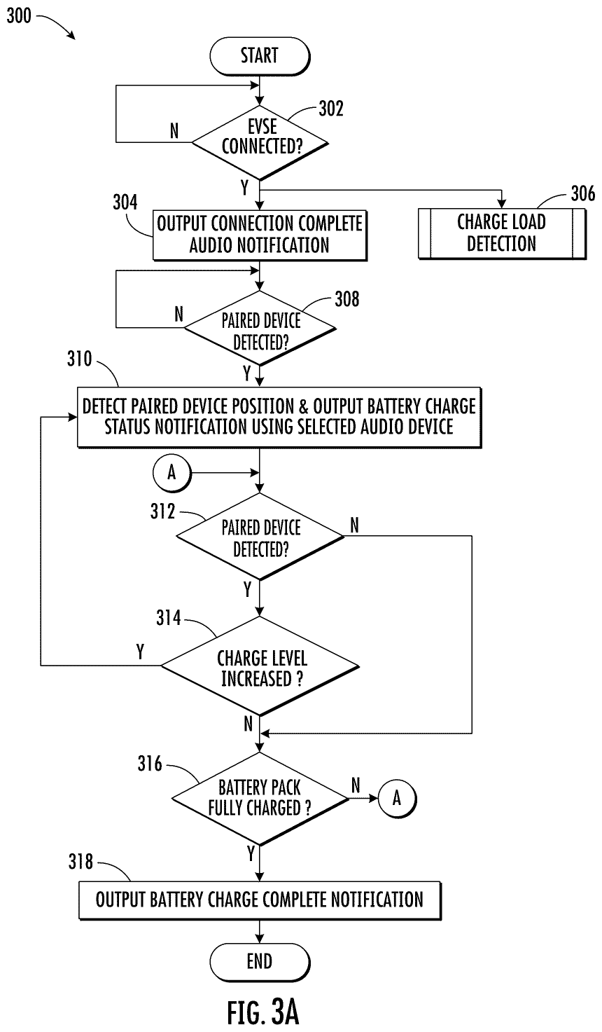

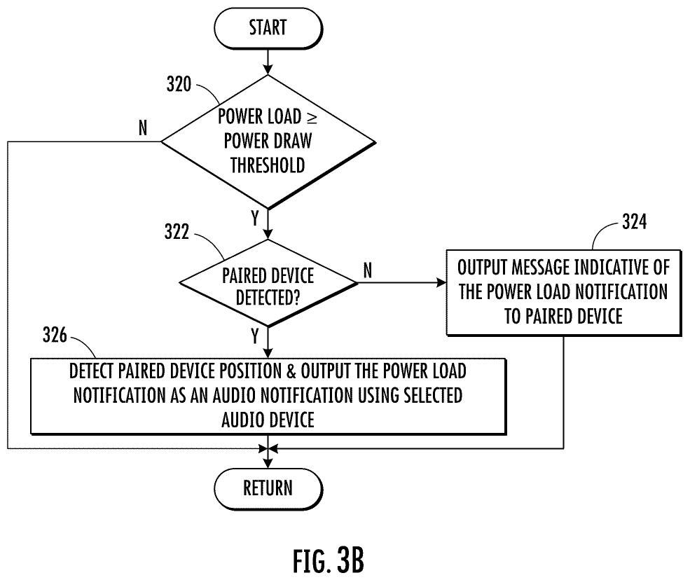

Referring to FIGS. 3A and 3B, an example charge notification routine 300 is provided and performed by the EV 100 of the present disclosure.

At operation 302, the EV 100 detects whether the EVSE 104 is connected to the EVSE interface 108. In a non-limiting example, the EV 100 detects connection using the proximity pin 114 of the EVSE interface 108.

If connected, the EV 100 outputs a connection complete audio notification at operation at 304. That is, once connected, the user is believed to be near the EVSE 104 and the EV 100, and therefore the audio notification may be provided to confer connection of the EVSE 104.

The EV 100 further performs a charge load detection at operation 306, which is described in reference to FIG. 3B.

At operation 308, the EV 100 determines if the paired device 145 is detected. In a non-limiting example, the EV 100 detects the paired device 145 using the SCD 142, such as a UWB device.

If detected, at operation 310, the EV 100 detects a position of the paired device 145 using the signal received from the paired device 145, as described above, and outputs a battery charge status notification using a selected audio device 150. With the paired device 145 being detected, the user 206 of the paired device 145 is believed to be in vicinity of the EV 100, and therefore, the EV 100 provides an audio notification providing the charge status of the battery pack 102, so as to inform the user of the charge level of the EV 100 (e.g., SOC of the battery pack 102). The audio device emitting audio notification may be selected based on the position of the paired device 145, as provided above.

At operation 312, the EV 100 determines if the paired device 145 is still detected or stated differently, if the user is in the audio zone 200 of the EV 100.

If the paired device is detected, the EV 100 determines if the charge level has increased to, for example, an incremental setpoint, at operation 316. For example, the EV 100 periodically provides the battery charge status notification when the charge level (e.g., SOC) of the battery pack 102 increases incrementally (e.g., every 5%).

If charge level increased to the incremental setpoint, the EV 100 returns to operation 310 to output the battery charge status notification via the selected audio device 150.

If the charge level has not increased to the incremental setpoint at operation 314 or the paired device 145 is not detected at operation 312, the EV 100 is configured to determine if the battery pack 102 is fully charged at operation 316. If the battery pack 102 is not fully charged, the EV 100 returns to operation 312.

If the battery pack 102 is fully charged, the EV 100 outputs a battery charge completion notification at operation 318. The battery charge completion notification may be an audio message if the paired device 145 is detected in the audio zone 200 and/or a message transmitted to the paired device 145.

Referring to FIG. 3B, for the charge load detection of operation 306, the EV 100 is configured to determine whether a power load on the battery pack 102 is greater than or equal to a power draw threshold, at operation 320. That is, the EV 100 determines if the power being drawn from the battery pack 102 during the charge operation is excessive as defined by the power draw threshold.

If the power load is excessive, the EV 100 outputs a power load notification. Specifically, the EV 100 determines if the paired device 145 is detected, at operation 322.

If the paired device 145 is not detected, the EV 100, at operation 324, outputs a message providing the power load notification indicating that the power load is excessive to the paired device 145. In a non-limiting example, the message may be transmitted using wireless communication protocol such as, but no limited to, BT or cellular protocol.

If the paired device 145 is detected, the EV 100, at operation 326, detects a position of the paired device 145, and outputs the power load notification as an audio notification using the selected audio device 150. The content provided in the power load notification for the message and the audio notification may be the same or may be different. In addition, if the paired device 145 is detected, the EV 100 may still transmit the message to the paired device 145.

The charge notification routine 300 of FIGS. 3A and 3B is just an example routine, and may be modified in accordance with the present disclosure. In a non-limiting example, in response to the EVSE 104 being connected to the EVSE interface 108, the EV 100 may determine if a charge operation is scheduled, as described above, prior to beginning the charge operation. In yet another example, the EV 100 is configured to detect the paired device 145 for a period of time (e.g., 3 second, 5 seconds, 10 seconds) prior to providing the battery charge notification to confer that the user is not just passing by the EV 100.

While specific audio notification are described, other types of audio notifications may be provided when the paired device is detected, such as but not limited to, notifications related to errors detected in the EVSE 104 and/or the EV 100, and/or premature disconnection of the EVSE 104 if the SOC of the EV 100 is below a set threshold (e.g., below 20%).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “controller” and/or “module” (e.g., PEM 120, BMM 126, DTM 144, control system 130, the COM 132) may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
charging a battery pack of a vehicle in response to an electric vehicle supply equipment (EVSE) being connected to a charge port of the vehicle;
detecting a position of a paired device associated with a vehicle user in response to receiving a wireless signal from the paired device; and
outputting a power load notification indicating excessive power being drawn from the battery pack in response to the battery pack being charged and a power load on the battery pack being greater than or equal to a power draw threshold, the power load notification being at least one of a message provided to the paired device or an audio signal outputted via a selected audio device of the vehicle in response to the position of the paired device being within an audio zone of the vehicle.

2. The method of claim 1, further comprising:
receiving the wireless signal from the paired device using a first wireless communication protocol; and
transmitting the message to the paired device using a second wireless communication protocol different from the first wireless communication protocol in response to the paired device being outside of the audio zone of the vehicle.

3. The method of claim 1, further comprising outputting a battery charge status audio notification from the selected audio device in response to the EVSE being connected to charge port of the vehicle and in response to the position of the paired device being within the audio zone of the vehicle.

4. The method of claim 3, wherein the battery charge status audio notification is periodically outputted based on a charge level of the battery pack and with the paired device being continuously within the audio zone of the vehicle.

5. The method of claim 3, wherein the battery charge status audio notification provides a present charge level of the battery pack in response to the wireless signal from the paired device being received after not being received.

6. The method of claim 1, further comprising identifying the selected audio device from among a plurality of audio devices based on the position of the paired device and information indicating placement of each audio device on the vehicle.

7. The method of claim 1, further comprising:
detecting the EVSE being connected to the charge port in response to a signal detected by a proximity pin of the charge port; and
outputting a connection complete audio notification from the selected audio device positioned in proximity to the charge port in response the EVSE being connected to the charge port.

8. The method of claim 7, wherein the connection complete audio notification includes information indicating one of the battery pack is charging or the battery pack is going to be charged at a scheduled time.

9. The method of claim 1, further comprising outputting an incomplete connection audio notification from the selected audio device positioned in proximity to the charge port in response the EVSE not being connected or only partially connected to the charge port.

10. A vehicle system, comprising:
a battery pack;
a plurality of audio devices defining an audio zone;
a first communication device configured to communicate using a first wireless communication protocol;
a plurality of second communication devices configured to communicate using a second wireless communication protocol and disposed at two or more known locations; and
one or more controllers configured to:
have the battery pack charged in response to an electric vehicle supply equipment (EVSE) being connected to a charge port;
detect a position of a paired device associated with a vehicle user in response to receiving a wireless signal from the paired device; and
output a power load notification indicating excessive power being drawn from the battery pack in response to the battery pack being charged and a power load on the battery pack being greater than or equal to a power draw threshold, the power load notification being at least one of a message provided to the paired device or an audio signal outputted via a selected audio device among the plurality of audio devices in response to the position of the paired device being within the audio zone.

11. The vehicle system of claim 10, wherein the one or more controllers are further configured to:
receive the wireless signal from the paired device using the first wireless communication protocol; and
transmit the message to the paired device using the second wireless communication protocol different from the first wireless communication protocol in response to the paired device being outside of the audio zone.

12. The vehicle system of claim 10, wherein the one or more controllers are further configured to output a battery charge status audio notification from the selected audio device in response to the EVSE being connected to charge port and in response to the position of the paired device being within the audio zone.

13. The vehicle system of claim 12, wherein the battery charge status audio notification is periodically outputted based on a charge level of the battery pack and with the paired device being continuously within the audio zone.

14. The vehicle system of claim 12, wherein the battery charge status audio notification provides a present charge level of the battery pack in response to the wireless signal from the paired device being received after not being received.

15. The vehicle system of claim 10, wherein the one or more controllers are further configured to identify the selected audio device from among the plurality of audio devices based on the position of the paired device and information indicating placement of each audio device.

16. The vehicle system of claim 10, wherein the one or more controllers are further configured to:
detect the EVSE being connected to the charge port in response to a signal detected by a proximity pin of the charge port; and
output a connection complete audio notification from the selected audio device positioned in proximity to the charge port in response the EVSE being connected to the charge port.

17. The vehicle system of claim 16, wherein the connection complete audio notification includes information indicating one of the battery pack is charging or the battery pack is going to be charged at a scheduled time.

18. The vehicle system of claim 10, wherein the one or more controllers are further configured to output an incomplete connection audio notification from the selected audio device positioned in proximity to the charge port in response the EVSE not being connected or only partially connected to the charge port.

19. The vehicle system of claim 10, wherein the second wireless communication protocol is a ultra-wide band type protocol.

20. A vehicle system, comprising:
a battery pack;
a plurality of audio devices defining an audio zone;
a first communication device configured to communicate using a first wireless communication protocol;
a plurality of second communication devices configured to communicate using a ultra-wide band communication protocol and disposed at two or more known locations; and
one or more controllers configured to:
have the battery pack charged in response to an electric vehicle supply equipment (EVSE) being connected to a charge port;
detect a position of a paired device associated with a vehicle user in response to receiving a wireless signal from the paired device;
identify a selected audio device from among the plurality of audio devices based on the position of the paired device and information indicating placement of each audio device;
output a power load notification indicating excessive power being drawn from the battery pack in response to the battery pack being charged and a power load on the battery pack being greater than or equal to a power draw threshold, the power load notification being at least one of a message provided to the paired device or an audio signal outputted via the selected audio device in response to the position of the paired device being within the audio zone; and
output a battery charge status audio notification from the selected audio device in response to the EVSE being connected to charge port and in response to the position of the paired device being within the audio zone.
